(19) United States
(12) Patent Application Publication
(10) Pub. No.: US 2004/0051806 A1
(43) Pub. Date: Mar. 18, 2004

(54) Integrated-circuit technology photosensitive sensor

(76) Inventors: Pierre Cambou, Grenoble (FR); Gilles Simon, Le Fontanil (FR); Gilles Boucharlat, Grenoble (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/451,666

(22) PCT Filed: Dec. 20, 2001
(86) PCT No.: PCT/FR01/04115

(30) Foreign Application Priority Data
Dec. 28, 2000 (FR) 00 17229

(51) Int. Cl. H04N 5/225

(52) U.S. Cl. 348/340

(57) ABSTRACT

The invention relates to photosensitive sensors, especially electronic image sensors made using CMOS integrated circuit technology.

The sensor (40) comprises a substrate (42) having an array of pixels (44) forming a photosensitive surface receiving light rays (r1, r2, r3, r4, r5, r6) and, in the path of the light rays, a holographic layer (48) having a recorded hologram, the holographic layer having an optical function corresponding to the inverse of a spatial scattering function so as to bring the light rays arriving on the layer at scattered oblique angles of incidence close to the normal to the sensitive surface.

The invention relates to photosensitive sensors, in particular electronic image sensors using CMOS integrated circuit technology, comprising small photosensitive pixels.

In electronic cameras, an electronic image sensor replaces the sensitive film of conventional cameras. These types of sensors comprising a photosensitive surface are used in low cost imaging, for example in digital cameras, mass-produced digital photographic equipment or optical sensors. In the embodiments for photographic cameras, the photosensitive surface of the sensor may, for example, be made of an arrangement of 480 lines of 640 photosensitive pixels per line. Each pixel supplies an electrical signal which is a function of the light intensity level that it receives. Electronics for processing the signals generate an electronic signal corresponding to the actual light image projected on the sensitive surface of the sensor.

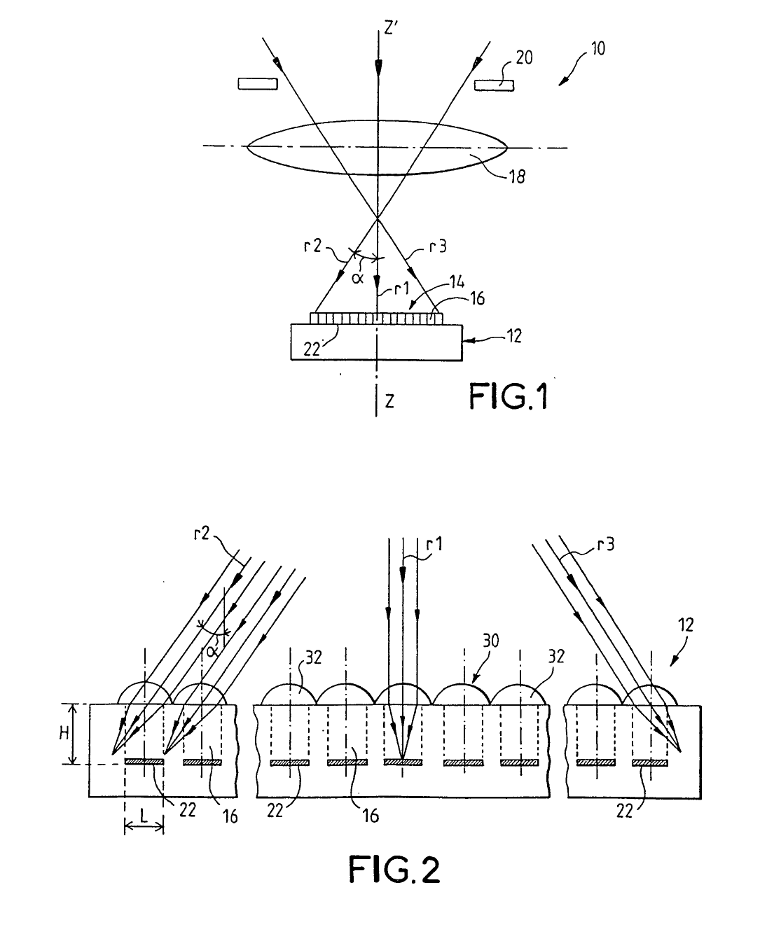

FIG. 1 shows a simplified embodiment of an electronic camera 10 using an image sensor 12 of CMOS type comprising a photosensitive surface 14 of pixels 16.

The electronic camera comprises a system, which is not telecentric for reasons of compactness, having a lens 18 and a diaphragm 20 focusing the light from the images aimed at by the camera onto the photosensitive surface 14 of the electronic sensor 12. Light rays r1, close to the optical axis ZZ′ of the optical system, have an angle of incidence which is substantially perpendicular to the photosensitive surface 14 of the sensor while the rays r2, r3 away from said optical axis ZZ′ arrive at the edges of the sensor with a certain inclination α with respect to a normal to this photosensitive surface 14.

The many layers of the substrate needed for producing the image sensor mean that the pixels 16 of the image sensor 12 act like wells for the light. A photosensitive zone 22 of the pixel is located at the bottom of each of these wells. Correct focusing of the light onto the photosensitive zone of the pixel is necessary, on the one hand, in order to obtain high pixel efficiency and, on the other hand, in order to partly recover the unused light arriving around the pixels. To this end, the current image sensors comprise a microlens array, each of the microlenses of the array, associated with a respective pixel, focusing the incident light on a pixel and around the pixel, on the photosensitive zone 22 of the pixel.

FIG. 2 shows a detailed view of the image sensor 12 of FIG. 1 comprising a microlens array 30 having one microlens 32 per pixel. The aim of the microlens 32 is to focus the light arriving at a pixel 16 onto a photosensitive zone 22 located in the bottom of the pixel. Currently, the size of the smallest pixels, with a width L of about 5 to 10 micrometers for a similar depth H of the pixel, is at the limiting dimensions of the size of microlenses that can be produced.

Such a microlens array 30 makes it possible to obtain better image sensor efficiency in a region of the sensor close to the optical axis ZZ′, but this efficiency decreases on moving away from this optical axis toward the periphery of the sensor. In fact (see FIG. 2), the rays r1 close to the optical axis ZZ′ and virtually parallel to this axis are properly focused on the photosensitive part 22 of the pixel, while the rays r2, r3 away from the center of the sensor 12 have an inclination a with respect to a normal to the surface of the sensor. The inclination a of the light rays is all the greater the further away the pixels in question are from the optical axis ZZ′, the focusing zone of the rays r2, r3 gradually moving toward the edges of the pixels. At the periphery of the sensor, the rays are no longer focused on the photosensitive zone 22 of the pixels but on the edges of the pixel well which then provides fewer electrical charges for the same light intensity received by the pixel.

Another significant drawback of the sensors of the prior art lies in the fact that the rays r2, r3 away from the optical axis, arriving obliquely on the photosensitive surface, may reach the sensitive zone of the neighboring pixel causing, on this neighboring pixel, parasitic modulation or crosstalk by a light ray not intended for it. In fact, the pixels of the optical sensors do not have opaque optical side separations, the side walls are relatively transparent and the oblique light rays are able to sweep the adjoining pixels.

To alleviate the drawbacks of the photosensitive sensors of the prior art, the invention provides a photosensitive sensor, in particular made using CMOS technology, comprising a substrate having an array of pixels forming a photosensitive surface receiving light rays, characterized in that it comprises, in the path of the light rays, a holographic layer having a recorded hologram, the holographic layer having an optical function corresponding to the inverse of a spatial scattering function so as to bring the light rays arriving on the layer at scattered oblique angles of incidence close to the normal to the photosensitive surface.

In a more sophisticated version, the function of bringing the incident rays arriving on a surface surrounding the pixel close to the normal to the photosensitive surface acts to concentrate them toward a pixel.

The invention also relates to a method of producing a photosensitive sensor, in particular made using CMOS technology, comprising a substrate having an array of pixels forming a sensitive surface receiving light rays, characterized in that a holographic layer having a recorded hologram is deposited on the surface of the sensor in the path of the light rays, the holographic layer having an optical function corresponding to the inverse of a spatial scattering function so as to bring the light rays arriving on the layer at scattered oblique angles of incidence close to the normal to the photosensitive surface.

In a first embodiment of the image sensor according to the invention, a holographic layer supporting the hologram is produced on the surface of the sensor then the hologram is recorded on the integral holographic layer of the sensor.

In another embodiment of the image sensor of the invention, the holographic layer comprising the hologram is made separately, then the layer is attached to the substrate of the photosensitive sensor.

The holographic layer, supported for example by a substrate which is transparent to light, comprises a holographic pattern recorded in its volume. The recorded pattern produces the desired optical function. The holographic layer may be made on a polycarbonate or polyester film, on a glass plate or on any other holographic support operating in transmission mode.

The invention will be better understood by means of exemplary embodiments of photosensitive sensors according to the invention with reference to the appended drawings, in which:

FIGS. 1 and 2, already described, show an image sensor of the prior art;

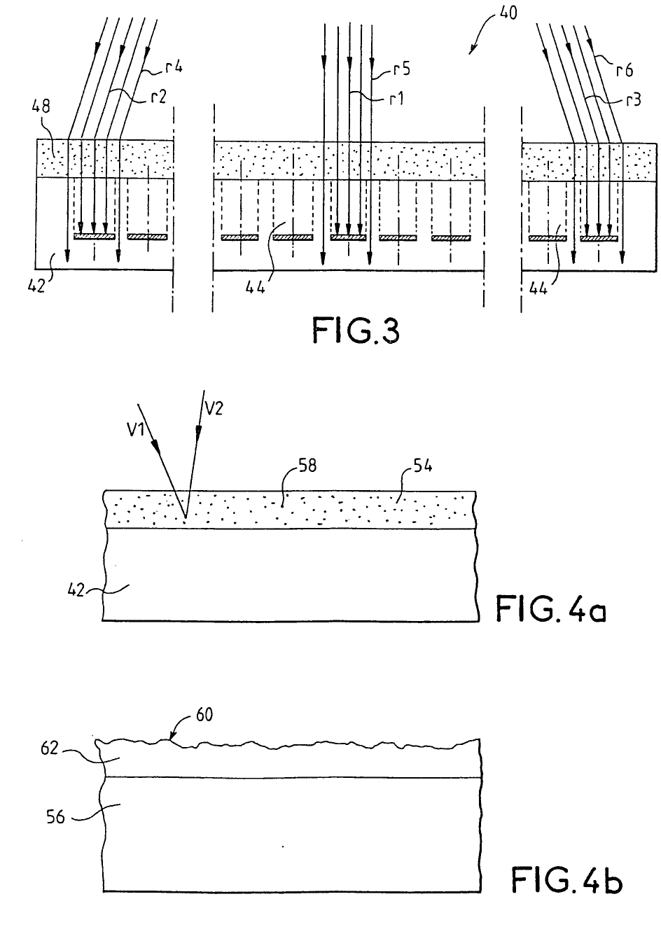

FIG. 3 shows an image sensor according to the invention comprising a holographic layer on the sensor;

FIG. 4a shows a holographic recording in the thickness of the holographic layer;

FIG. 4b shows a holographic recording in relief on the holographic layer;

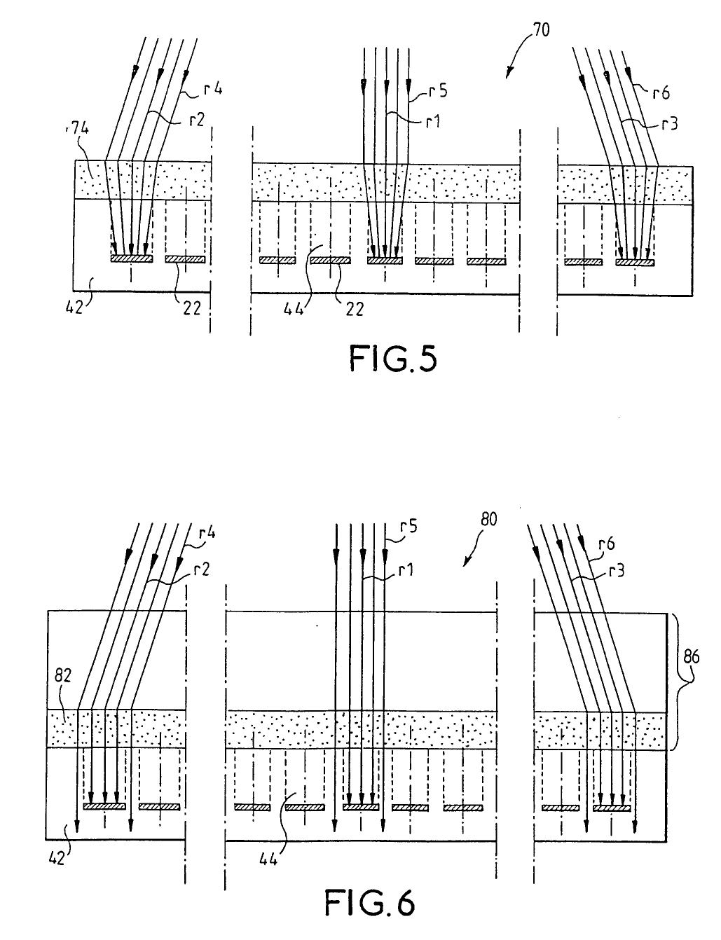

FIG. 5 shows a first variant embodiment of the image sensor of FIG. 3;

FIG. 6 shows another embodiment of the image sensor according to the invention.

FIG. 3 shows a first embodiment of an electronic image sensor 40 according to the invention used, for example, in an electronic camera. The image sensor mainly comprises a substrate 42 having a pixel array 44 made using CMOS technology and forming a photosensitive surface and a holographic layer 48, deposited on the substrate 42, producing the desired optical function.

The method of producing the image sensor according to the invention comprises at least the following steps:

producing the pixel array 44, made using CMOS technology and forming the photosensitive surface, on the substrate 42;

depositing the holographic layer 48 on the substrate;

recording, in the holographic layer 48, a hologram having an optical function tending to bring light rays arriving on the surface of the layer at scattered oblique angles of incidence close to a normal to the surface of the holographic layer.

The holographic layer 48 comprises a holographic interference pattern producing the desired optical function. Such a hologram having an optical function tending to bring light rays r1, r2, r3 arriving on the layer at scattered oblique angles of incidence close to a normal to the surface of the holographic layer 48 may, for example, be obtained by producing holographic patterns in the thickness of the holographic layer of a series of interferences between two coherent light waves, each of the interferences being produced by the interference of a first wave arriving, for example, from one side of the layer with a predetermined angle with respect to this layer and of a second wave arriving from the other side of the layer with an interference angle with respect to the surface of the layer which will be changed for each interference, the variation of this interference angle sweeping out a solid angle of the scattered oblique incident waves that it is desired to bring close to the normal to the surface of the layer.

In the embodiment of FIG. 3, light rays r1, r2, r3, coming from the optical system of the camera, arrive with an oblique angle of incidence with respect to the normal to the surface of the image sensor, varying as a function of the position of arrival of the rays on the sensitive surface of the sensor. On crossing the holographic layer, the rays r1, r2, r3 are brought close to the normal to the sensitive surface of the sensor. In particular, the rays arriving at pixels located close to the edges of the sensor and having the greatest inclination with respect to the normal to the sensor, are brought close to this normal by the optical action of the holographic layer 48.

This bringing of the light rays r1, r2, r3 close to the normal to the sensor results in an appreciable increase in the illumination of the pixels located close to the edges of the sensor and an improvement in their efficiency. Among the advantages of bringing the light rays close to the normal to the sensor, mention may be made of:

the homogenization of the sensitivity of the sensor, whatever the given location of the sensitive surface of the sensor;

the decrease in interpixel crosstalk, particularly on the edges of the sensor, the parasitic illumination by light rays intended for neighboring pixels being substantially reduced.

The hologram can be recorded within the volume of a photosensitive holographic layer. FIG. 4a shows such a recording of the holographic pattern in the thickness of the holographic layer 48 of the image sensor of FIG. 3 according to the invention. To this end, a photosensitive layer 54 is exposed to two coherent light waves V1 and V2 producing an interference pattern 58 in the photoresist layer 54. The holographic pattern 58 produces the desired optical function.

The hologram can be recorded in the holographic layer in other known ways, that is:

by printing the holographic pattern in relief on a thermoplastic layer. FIG. 4b shows recording of this sort, during which a holographic relief pattern 60 is stamped by compressing the surface of a thermoplastic layer 62 fastened to a support 56, by means of a die made of a hard material and comprising a complementary relief pattern of the pattern to be printed. The support 56 may also be the substrate 42 of the electronic image sensor,

or by exposing a photoresist layer to radiation, producing the holographic interference pattern. The photoresist layer is then developed in order to obtain a relief pattern on the surface of the holographic layer.

The embodiment of the image sensor of FIG. 3 according to the invention provides a clear improvement in performance with respect to the sensors of the prior art using an effect of channeling the light rays toward the sensitive zones of the pixels and in particular an improvement of the signal-to-noise ratio of the electronic signal generated by the sensor.

FIG. 5 shows a variant embodiment of the image sensor of FIG. 3 providing an additional improvement in pixel efficiency. In this variant, the holographic layer, in addition to the effect of bringing light rays closer to a normal to the sensor toward the sensitive region of the pixels, comprises another additional effect of concentrating the rays toward the sensitive region 22 of the pixels. This is because, in the embodiment of FIG. 3, rays r4, r5, r6 illuminate the parts surrounding the sensitive zone of the pixels which do not produce electrical charges useful for generating the electrical signal representing the image.

In this variant, an image sensor 70 comprises the substrate 42 having the pixel array 44 made using CMOS technology forming a photosensitive surface and a holographic layer 74 on the substrate 42, the optical concentration function of the holographic layer acting in order to concentrate the incident rays arriving on a surface surrounding the pixel toward a pixel.

FIG. 6 shows another embodiment of the photosensitive sensor 80 according to the invention comprising a holographic layer 82 having recordings of holographic patterns of the layers of the embodiments previously described. In this other embodiment of FIG. 6, the holographic layer comprising the hologram is made separately, then is attached to the substrate 42 of the photosensitive sensor.

According to the embodiment of FIG. 6, a photosensitive sensor 80 according to the invention comprises at least the following manufacturing steps:

production of the pixel array 44 made using CMOS technology and forming the photosensitive surface, on the substrate 42;

production of the holographic layer 82 on a support 86 which is transparent to light;

recording of the hologram on the layer supporting the hologram according to known techniques, either by thermoforming, or by photographic revelation,

depositing the support 86 comprising the holographic layer on the surface of the substrate, in the path of the light rays.

As for the embodiments of sensors of FIGS. 3 and 5, the rays r4, r5, r6 arriving on a surface surrounding the pixel may be concentrated, in this variant of FIG. 6, by the holographic layer, toward the sensitive zone of the pixel.

The holographic interference pattern is the result of combining two coherent light waves in the sensitive layer, a first incident wave coming directly from the coherent light source and a second wave coming from the same source but illuminating the object of which it is desired to record the hologram corresponding to the desired optical function. This is a recording by natural means.

The hologram may be of synthetic type. In this case, the holographic interference pattern may be made by computer calculation, which has the advantage of being able to produce holographic patterns corresponding to optical functions which cannot be obtained using recording by natural means. The synthetic holograms are used in order to produce optical functions of frequency or display filtering or for producing optical elements. Holographic patterns can also be recorded by combining natural holograms and synthetic holograms.

The hologram recorded in the holographic layer of the image sensor according to the invention makes it possible to obtain various optical functions needed for the optical sensors flexibly and easily. However, other possibilities are also offered by holograms such as color filtering for color cameras. To this end, the holographic layer, in addition to the optical functions of the embodiments described, comprises functions of optically filtering the three primary colors, red, green and blue.

In the image sensors for the photographic or video frequency cameras, it is sought to produce an electrical signal corresponding to the visible light coming from the object to be displayed. It is therefore not desirable to illuminate the pixels of the sensor by invisible light. To this end, in a third embodiment of the image sensor according to the invention, the holographic layer comprises a hologram producing an optical function of filtering infrared rays that are not useful for the camera.

The application of the sensor according to the invention is not limited to the image sensors of cameras. In some types of optical sensors, the light is transmitted to a photosensitive pixel via an optical fiber, the output end of which is located opposite this pixel. The light moves in the optical fiber by reflection on the walls of the fiber. The light emitted at the end of the fiber has a nonzero angle with respect to the normal to the sensitive zone of the pixel. The holographic layer, as described in the invention, brings the light emerging from the fiber close to this normal to the sensitive zone of the pixel, with the advantages mentioned above.

1. A photosensitive sensor, in particular made using CMOS technology, comprising a substrate having an array of pixels (16, 44) forming a photosensitive surface receiving light rays (r1, r2, r3, r4, r5, r6), characterized in that it comprises, in the path of the light rays, a holographic layer (48, 74, 82) having a recorded hologram, the holographic layer having an optical function corresponding to the inverse of a spatial scattering function so as to bring the light rays arriving on the layer at scattered oblique angles of incidence close to the normal to the photosensitive surface.

2. The photosensitive sensor as claimed in claim 1, characterized in that the function of bringing the incident rays arriving on a surface surrounding the pixel close to the normal to the photosensitive surface acts to concentrate them toward a pixel (44).

3. The photosensitive sensor as claimed in either of claims 1 and 2, characterized in that the holographic layer has functions of optically filtering the three primary colors, red, green and blue, of color cameras.

4. The photosensitive sensor as claimed in one of claims 1 to 3, characterized in that the holographic layer comprises a hologram producing an optical function of filtering infrared rays.

5. A method of producing a photosensitive sensor, in particular made using CMOS technology, comprising a substrate (42) having an array of pixels (44) forming a sensitive surface receiving light rays (r1, r2, r3, r4, r5, r6), characterized in that a holographic layer (48, 74, 82) having a recorded hologram is deposited on the surface of the sensor in the path of the light rays, the holographic layer having an optical function corresponding to the inverse of a spatial scattering function so as to bring the light rays arriving on the layer at scattered oblique angles of incidence close to the normal to the photosensitive surface.

6. The method of producing a photosensitive sensor as claimed in claim 5, characterized in that the recorded hologram is obtained by producing holographic patterns in the thickness of the holographic layer (48, 74, 82) of a series of interferences between two coherent light waves, each of the interferences being produced by the interference of a first wave arriving from one side of the layer with a predetermined angle with respect to this layer and of a second wave arriving from the other side of the layer with an interference angle with respect to the surface of the layer which will be changed for each interference, the variation of this interference angle sweeping out a solid angle of the scattered oblique incident waves that it is desired to bring close to the normal to the surface of the layer.

7. The method of producing a photosensitive sensor as claimed in either of claims 5 and 6, characterized in that the holographic layer (82) comprising the hologram is made separately, then the layer is attached to the substrate (42) of the photosensitive sensor.

8. The method of producing a photosensitive sensor as claimed in one of claims 5 to 7, characterized in that the holographic layer (48, 74) may be made on a polycarbonate or polyester film, on a glass plate or on any other holographic support operating in transmission mode.

9. The method of producing a photosensitive sensor as claimed in either of claims 5 and 6, characterized in that a holographic layer (48) supporting the hologram is deposited on the surface of the image sensor then the hologram is made on the integral holographic layer of the sensor.

10. The method of producing a photosensitive sensor as claimed in claim 9, characterized in that a holographic layer (48) supporting the hologram is deposited on the substrate (42) of the sensor when the silicon wafers comprising a plurality of photosensitive sensors are manufactured.

11. The method of producing a photosensitive sensor as claimed in claim 10, characterized in that the holographic layer (62, 82) is a thermoplastic layer, the hologram being recorded by thermoforming.

12. The method of producing a photosensitive sensor as claimed in claim 10, characterized in that the holographic layer is a layer made of photosensitive gelatin, the hologram being recorded by photographic revelation.

13. The method of producing a photosensitive sensor as claimed in one of claims 5 to 9, characterized in that the hologram is recorded in the holographic layer (48, 74, 82) by printing the holographic pattern in relief on a thermoplastic layer fastened to the support (50, 56) by means of a die made of a hard material and comprising a complementary relief pattern of the pattern to be printed.

14. The method of producing a photosensitive sensor as claimed in one of claims 5 to 9, characterized in that the hologram is recorded in the holographic layer (62, 82) by exposing a photoresist layer to radiation producing the holographic interference pattern, the photoresist layer then being developed in order to obtain a relief pattern (60) on the surface of the holographic layer.

15. The method of producing a photosensitive sensor as claimed in claims 5 to 13, characterized in that the holographic interference pattern is the result of combining two coherent light waves (V1, V2) in the holographic layer (48, 58, 74, 82), a first incident wave coming directly from the coherent light source and a second wave coming from the same source but illuminating the object of which it is desired to record the hologram corresponding to the desired optical function.

16. The method of producing a photosensitive sensor as claimed in one of claims 5 to 13, characterized in that the hologram may be of synthetic type, the holographic interference pattern being produced by computer calculation.
